(19) United States
(12) Patent Application Publication
(10) Pub. No.: US 2026/0066508 A1
(43) Pub. Date: Mar. 5, 2026

(54) SECONDARY BATTERY AND METHOD OF MANUFACTURING THE SAME

(71) Applicant: SAMSUNG SDI CO., LTD., Yongin-si (KR)

(72) Inventor: Jiwon YUN, Yongin-si (KR)

(21) Appl. No.: 19/021,488

(22) Filed: Jan. 15, 2025

(30) Foreign Application Priority Data
Aug. 28, 2024 (KR) 10-2024-0115911

(51) Int. Cl. H01M 50/593; H01M 50/109; H01M 50/153; H01M 50/449; H01M 50/536; H01M 50/586; H01M 50/588

(52) U.S. Cl. CPC H01M 50/593; H01M 50/109; H01M 50/153; H01M 50/449; H01M 50/536; H01M 50/586; H01M 50/588

(57) ABSTRACT

A secondary battery includes an electrode assembly including a first electrode with a first electrode tab, a separator, and a second electrode with a second electrode tab, a case accommodating the electrode assembly, the case being electrically connected to the second electrode tab, a cap assembly that seals an open one side of the case, the cap assembly being electrically connected to the first electrode tab, and an insulation sheet attached to the cap assembly, the insulation sheet electrically insulating the first electrode tab from the electrode assembly.

### CROSS-REFERENCE TO RELATED APPLICATION

The present application claims priority to and the benefit of Korean Application No. 10-2024-0115911, filed on Aug. 28, 2024, in the Korean Intellectual Property Office, the entire disclosure of which is incorporated by reference herein.

### BACKGROUND

### 1. Field

The present disclosure relates to a secondary battery and a method of manufacturing the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A secondary battery may include an electrode assembly with an electrode tab formed therein, a case which has an open one side and in which the electrode assembly is accommodated, and a cap assembly with which the open one side of the case is sealed and to which the electrode tab is combined. Then, an insulation sheet may be disposed between the electrode assembly and the electrode tab to insulate the electrode tab and the electrode assembly.

The above information disclosed in this Background section is for enhancement of understanding of the background of the present disclosure, and therefore, it may contain information that does not constitute related (or prior) art.

### SUMMARY

According to one or more embodiments of the present disclosure, a secondary battery includes an electrode assembly including a first electrode with a first electrode tab formed therein, a separator, and a second electrode with a second electrode tab formed therein, a case in which the electrode assembly is accommodated and which is electrically connected to the second electrode tab, a cap assembly that seals an open one side of the case, and is electrically connected to the first electrode tap, and an insulation sheet that is attached to the cap assembly and electrically insulates the first electrode tap and the electrode assembly.

In some embodiments, the insulation sheet may include an insulation layer made of an insulation material, and an adhesive layer that may be formed on one side of the insulating layer, and attaches the insulating layer to the cap assembly.

In some embodiments, a thickness of the adhesive layer may be equal to or greater than a size of a burr protruding outward formed on the first electrode tap.

In some embodiments, the cap assembly may include: a cap plate that may include a through hole and may be coupled to the case, a terminal plate that may be disposed on an outer peripheral surface of the cap plate, and may include a protrusion inserted into the through hole and coupled to the first electrode tap, an outer insulator that may be disposed between the cap plate and the terminal plate, and insulates the cap plate and the terminal plate, and an inner insulator that may include an insertion hole corresponding to the through hole, may be disposed on an inner peripheral surface of the cap plate, and insulates the first electrode tap and the cap plate.

In some embodiments, the insulation sheet may be attached to the inner insulator such that the first electrode tab may not be exposed.

In some embodiments, a diameter of the insulation sheet may be larger than a diameter of the insertion hole, and may be equal to or less than a diameter of the inner insulator.

In some embodiments, a diameter of the insulation sheet may be larger than a diameter of the insertion hole, and may be equal to or less than a diameter of the electrode assembly.

In some embodiments, the first electrode tab may include an insulation tape attached to an area such that a part to be coupled to the protrusion may be exposed.

In some embodiments, a diameter of the insulation sheet may be larger than a diameter of the insertion hole when the insulation sheet may be attached to the insulation tape.

According to one or more embodiments of the present disclosure, a method of manufacturing a secondary battery, includes accommodating an electrode assembly including a first electrode with a first electrode tab formed therein, a separator, and a second electrode with a second electrode tab formed therein, in a case, disposing a cap assembly to be in contact with the first electrode tap, combining the first electrode tap to the cap assembly, attaching an insulation sheet to the cap assembly such that the first electrode tab may not be exposed, and combining the cap assembly to the case.

In some embodiments, disposing the cap assembly may include disposing the cap assembly in a perpendicular direction with respect to the case.

In some embodiments, combining the cap assembly to the case may include irradiating the first electrode tab with a laser to combine the first electrode tap to the cap assembly by laser welding,

In some embodiments, the insulation sheet may include an insulation layer made of an insulation material, and an adhesive layer that may be formed on one side of the insulating layer, and attaches the insulating layer to the cap assembly.

In some embodiments, a thickness of the adhesive layer may be equal to or greater than a size of a burr protruding outward formed on the first electrode tap.

In some embodiments, the cap assembly may include a cap plate that may include a through hole and may be coupled to the case, a terminal plate that may be disposed on an outer peripheral surface of the cap plate, and may include a protrusion inserted into the through hole and coupled to the first electrode tap, an outer insulator that may be disposed between the cap plate and the terminal plate, and insulates the cap plate and the terminal plate, and an inner insulator that may include an insertion hole corresponding to the through hole, may be disposed on an inner peripheral surface of the cap plate, and insulates the first electrode tap and the cap plate.

In some embodiments, attaching an insulation sheet to the cap assembly may include attaching the insulation sheet to the inner insulator such that the first electrode tab may not be exposed.

In some embodiments, a diameter of the insulation sheet may be larger than a diameter of the insertion hole, and may be equal to or less than a diameter of the inner insulator.

In some embodiments, a diameter of the insulation sheet may be larger than a diameter of the insertion hole, and may be equal to or less than a diameter of the electrode assembly.

In some embodiments, the first electrode tab may include an insulation tape attached to an area such that a part to be coupled to the protrusion may be exposed.

In some embodiments, a diameter of the insulation sheet may be larger than a diameter of the insertion hole when the insulation sheet may be attached to the insulation tape.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a cross-section showing an example of a secondary battery according to some embodiments of the present disclosure.

FIG. 2 is an exploded perspective view showing an example of a secondary battery according to some embodiments of present disclosure.

FIG. 3 is an exploded cross-sectional view showing an example of a cap assembly in a secondary battery according to some embodiments of present disclosure.

FIGS. 4 and 5 are enlarged view showing an example of area A of FIG. 1.

FIG. 6 is a plan view showing an example of an attached insulation sheet, in a secondary battery according to some embodiments of the present disclosure.

FIGS. 7 and 8 are diagrams showing an example of a method of manufacturing a secondary battery according to some embodiments of the present disclosure.

FIG. 9 is a flow chart of an example of a method of manufacturing the secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

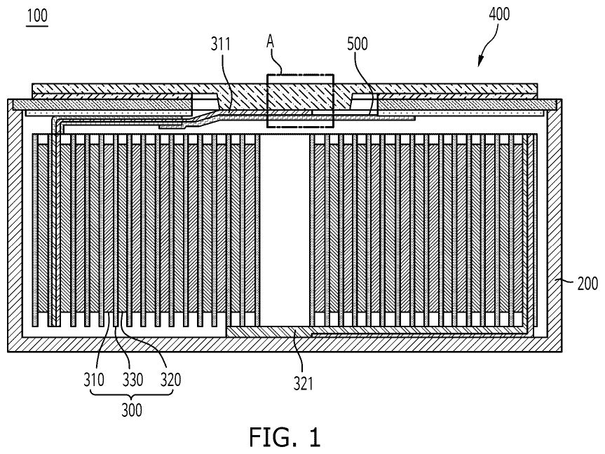

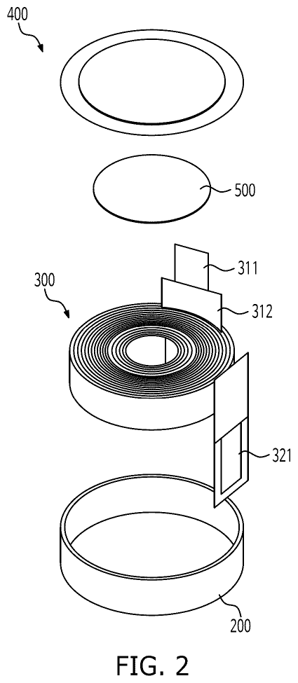

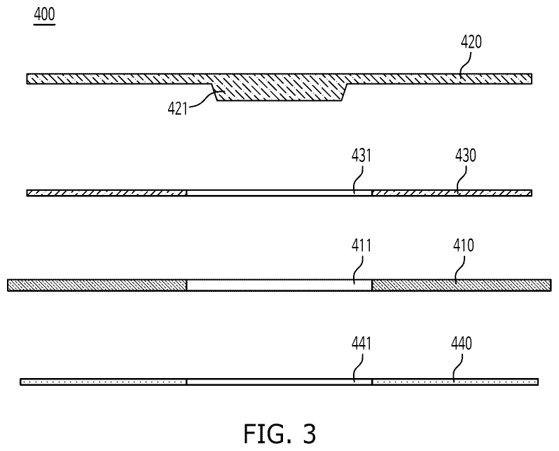

FIG. 1 is a cross-section showing an example of a secondary battery according to some embodiments of the present disclosure, FIG. 2 is an exploded perspective view showing an example of the secondary battery according to some embodiments of present disclosure, and FIG. 3 is a separated cross-sectional view showing an example of a cap assembly in the secondary battery according to some embodiments of present disclosure.

Referring to FIGS. 1 to 3, a secondary battery 100 according to some embodiments of the present disclosure may include an electrode assembly 300 including a first electrode 310 with a first electrode tab 311 formed therein, a separator 330, and a second electrode 320 with a second electrode tab 321 formed therein, a case 200 in which the electrode assembly 300 is accommodated and which is electrically connected to the second electrode tab 321, a cap assembly 400 that seals an open one side of the case 200, and is electrically connected to the first electrode tab 311, and an insulation sheet 500 that is attached to the cap assembly 400 and electrically insulates the first electrode tab 311 and the electrode assembly 300.

The electrode assembly 300 may include the separator 330 and the first electrode 310 and the second electrode 320 positioned with the separator 330 interposed therebetween and may be wound in a jelly-roll shape.

The first electrode 310 includes a first substrate and a first active material layer on the first substrate. The first electrode tab 311 may extend outwardly from a first uncoated portion of the first substrate at where the first active material layer is not located, and the first electrode tab 311 may be electrically connected to the cap assembly 400.

The second electrode 320 includes a second substrate and a second active material layer on the second substrate. The second electrode tab 321 may extend outwardly from a second uncoated portion of the second substrate at where the second active material layer is not located, and the second electrode tab 321 may be electrically connected to the case. The first electrode tab 311 and the second electrode tab 321 may extend in opposite directions.

The first electrode 310 may act as a positive electrode. In such some embodiments, the first substrate may be made of, for example, an aluminum foil, and the first active material layer may include, for example, a transition metal oxide. The second electrode 320 may act as a negative electrode. In such some embodiments, the second substrate may be made of, for example, a copper foil or a nickel foil, and the second active material layer may include graphite, for example.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

The separator 330 prevents a short circuit between the first electrode 310 and the second electrode 320 while allowing movement of lithium ions therebetween. The separator 330 may be made of, for example, a polyethylene film, a polypropylene film, a polyethylene-polypropylene film, or the like.

The separator 330 may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

The case 200 accommodates the electrode assembly 300 and, together with the cap assembly 400, forms the external appearance of the secondary battery. The case 200 may have a substantially cylindrical body portion and a bottom portion connected to one side (e.g., to one end) of the body portion. The case may be made of a metal, such as aluminum, aluminum alloy, or nickel-plated steel. The second electrode tab 321 may be attached to the bottom of the case 200 and be electrically connected to the bottom of the case 200.

Referring to FIG. 3, the cap assembly 400 may include a cap plate 410 having a through hole 411 formed therein, a terminal plate 420 including a protrusion 421 disposed on the cap plate 410 and inserted into the through hole 411, an outer insulator 430 that is disposed between the cap plate 410 and the terminal plate 420, and an inner insulator 440 that is disposed on the inner peripheral surface of the cap plate 410 and insulates the first electrode tab 311 and the cap plate 410.

For example, the cap plate 410 may be formed in a disc shape with the through hole 411 formed in the center of the cap plate 410. The cap plate 410, as shown in FIG. 3, may be formed to have a larger outer diameter than each of the terminal plate 420 and the outer insulator 430. The cap plate 410 may be inserted and disposed in a fastening groove recessed at an upper end of the case 200 to close the opening of the case 200. In another example, the cap plate 410 may be made into various shapes corresponding to the shape of the case to which it is fastened.

For example, the terminal plate 420 may be formed in a disc shape having a smaller diameter than the cap plate 410, and the protrusion 421 may be formed in the center of the terminal plate 420 to be inserted into the through hole 411 of the cap plate 410. The protrusion 421 may be formed to protrude outward of the cap plate 410 while inserted into the through hole 411. The first electrode tab 311 may be attached to the protrusion 421. In another example, the terminal plate 420 may be made into various shapes corresponding to the shape of the cap plate 410. Thus, the first electrode tab 311 may be attached to the protrusion 421, and the second electrode tab 321 may be attached to the case 200, so that the terminal plate 420 may function as the positive electrode and the case 200 may function as the negative electrode.

The outer insulator 430 may be disposed between the cap plate 410 and the terminal plate 420 so that the cap plate 410 and the terminal plate 420 may be electrically insulated from each other. The cap plate 410 and terminal plate 420 may be made of conductive metal material and may be electrically connected to the negative electrode which is the second electrode tab 321 and the positive electrode which is the first electrode tab 311, respectively, so that the outer insulator 430 may prevent a short circuit from occurring by insulating the cap plate 410 and the terminal plate 420 from each other. For example, the outer insulator 430 may be made of a resin such as polypropylene (PP) or polyethylene (PE).

The outer insulator 430 may be formed in a disc shape with an insertion hole 431 formed in the center of the outer insulator 430, similar to the cap plate 410. Through this, the protrusion 421 of the terminal plate 420 may be disposed to penetrate the insertion hole 431 of the outer insulator 430 and the through hole 411 of the cap plate 410 to be attached to the first electrode tab 311. The outer diameter of the outer insulator 430 may be equal to or similar to the outer diameter of the terminal plate 420. The cap plate 410 may be formed to have an outer diameter greater than the outer insulator 430 and terminal plate 420. The diameter of the insertion hole 431 of the outer insulator 430 may be equal to or similar to the diameter of the through hole 411 of the cap plate 410. The outer insulator 430 may be disposed between the cap plate 410 and the terminal plate 420, by heating and pressing the cap plate 410 and terminal plate 420, the outer insulator 430 may be attached to the cap plate 410 and terminal plate 420 by heat fusion method.

The inner insulator 440 may be disposed between the cap plate 410 and the first electrode tab 311, so that the cap plate 410 and the first electrode tab 311 may be electrically insulated. The cap plate 410 and the first electrode tab 311 may be made of conductive metal material, the cap plate 410 may be electrically connected to the negative electrode through the second electrode tab 321, and the first electrode tab 311 may be electrically connected to the positive electrode. Therefore, the inner insulator 440 may prevent a short circuit from occurring by insulating the cap plate 410 and the first electrode tab 311 from each other. For example, the inner insulator 440 may be made of a resin such as polypropylene (PP) or polyethylene (PE).

The inner insulator 440 may be formed in a disc shape with an insertion hole 441 formed in the center of the inner insulator 440, similar to the cap plate 410. Through this, the protrusion 421 of the terminal plate 420 may be disposed to penetrate the insertion hole 441 of the inner insulator 440 and the through hole 411 of the cap plate 410 to be attached to the first electrode tab 311. The outer diameter of the inner insulator 440 may be smaller than the outer diameter of the cap plate 410. As the end of the cap plate 410 may be coupled to the case 200, the inner insulator 440 may be formed to be smaller than the cap plate 410 in the outer diameter, e.g., and the inner insulator 440 may be completely within the case 200.

The diameter of the insertion hole 441 of the inner insulator 440 may be equal to or similar to the diameter of the through hole 411 of the cap plate 410, e.g., the diameters of the insertion hole 441 of the inner insulator 440, the insertion hole 431 of the outer insulator 430, and the through hole 411 of the cap plate 410 may be aligned and vertically overlap each other. The inner insulator 440 may be formed by coating the inner peripheral surface of the cap plate 410 with an insulation material or by attaching an insulation film.

For example, the secondary battery described with reference to FIG. 1 may be a coin-type or button-type battery. In another example, other types of secondary batteries (e.g., cylindrical batteries) may be used. In addition, FIG. 1 shows that the first electrode tab 311 protrudes to the top and is connected to the cap assembly 400, and the second electrode tab 321 protrudes to the bottom and is connected to the case 200, but both the first electrode tab and the second electrode tab may protrude to the top and may be connected to the cap assembly and the case, respectively.

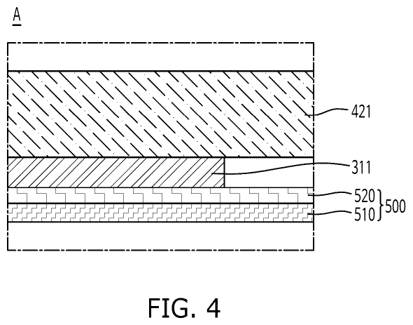

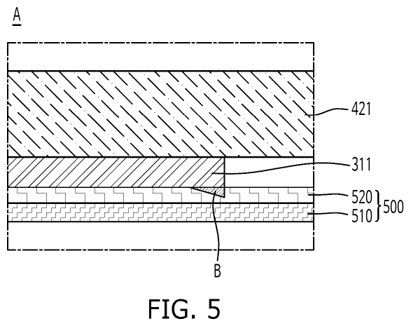

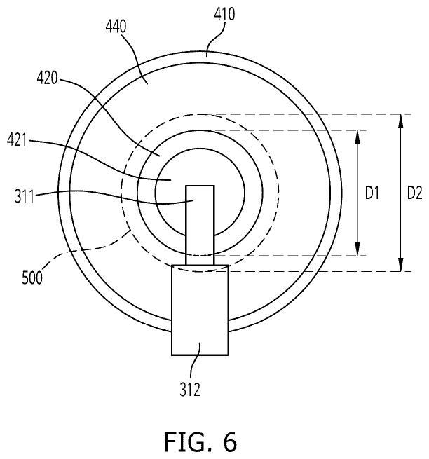

FIGS. 4 and 5 are enlarged view showing an example of area A of FIG. 1, and FIG. 6 is a plan view showing an example in which the insulation sheet is attached, in the secondary battery according to some embodiments of the present disclosure.

Referring to FIGS. 4 to 6, the insulation sheet 500 according to some embodiments of the present disclosure may be attached to the cap assembly 400 to be located on the first electrode tab 311 connected to the cap assembly 400 so that the first electrode tab 311 and the electrode assembly 300 may be electrically insulated. For example, referring to FIGS. 1, 3, and 4, the insulation sheet 500 may vertically overlap and be in direct contact with the first electrode tab 311 and the inner insulator 440 of the cap assembly 400. For example, referring to FIGS. 1 and 4, an edge of the first electrode tab 311 connected to the protrusion 421 of the terminal plate 420 may be directly between the protrusion 421 and the insulation sheet 500.

In some embodiments, the insulation sheet 500 may include an insulating layer 510 made of an insulation material, and an adhesive layer 520 that is formed on one side of the insulating layer 510 and attaches the insulating layer 510 to the cap assembly 400. For example, the insulating layer 510 may be made of a resin such as polypropylene (PP), polyethylene (PE), or polyethylene terephthalate (PET). The adhesive layer 520 may be formed by attaching an adhesive material to one side of the insulating layer 510, or by attaching a double-sided tape to one side of the insulating layer 510. For example, referring to FIG. 4, the adhesive layer 520 may be formed on a surface of the insulating layer 510 facing the cap assembly 400.

The adhesive layer 520 may be formed to have a thickness equal to or greater than a size (e.g., thickness) of a burr protruding outward formed on the first electrode tab 311, referring to FIG. 5. The first electrode tab 311 may be formed by a slitting process or a notching process. When cut by this process, a burr B may be formed to protrude at the end (e.g., terminal edge) of the first electrode tab 311. The burr B may be formed to be pointed to cause damage to the insulating layer 510 (e.g., the burr B may have a sharp or pointed edge facing the insulating layer 510). Thus, the adhesive layer 520 may be formed to have a thickness equal to or greater than a height of the burr B (e.g., to completely cover the burr B), so that the insulating layer 510 may be prevented from being broken by the burr B (e.g., the adhesive layer 520 may completely separate between the burr B and the insulating layer 510 to prevent contact between the burr B and the insulating layer 510).

The adhesive layer 520 of the insulation sheet 500 may be attached to the inner insulator 440. In this case, the insulation sheet 500 may be attached to the inner insulator 440 such that the first electrode tab 311 is not exposed. Consequently, the diameter D2 of the insulation sheet 500 may be greater than the diameter D1 of the insertion hole formed on the inner insulator 440 (FIG. 6), and may be equal to or smaller than the diameter of the inner insulator 440. For example, referring to FIGS. 1 and 6, the insulation sheet 500 may completely overlap the through hole 411 of the inner insulator 440 (e.g., the insulation sheet 500 may extend radially beyond the through hole 411 of the inner insulator 440 to contact and attach to the inner insulator 440). The insulation sheet 500 may be attached to the inner insulator 440 to increase the adhesion of the insulation sheet 500. Consequently, a minimum diameter of the insulation sheet 500 may be larger than the diameter D1 of the through hole 411 of the inner insulator 440. The insulation sheet 500 may be formed to have a maximum diameter smaller than an outer diameter of the inner insulator 440 not to interfere the assembly of the cap plate 410 and the case 200.

In another example, the diameter D2 of the insulation sheet 500 may be greater than the diameter D1 of the insertion hole of the inner insulator 440 and may be equal to or less than the diameter of the electrode assembly. A minimum diameter of the insulation sheet 500 may be larger than the diameter D1 of the through hole 411 of the inner insulator 440 such that the insulation sheet 500 is attached to the inner insulator 440. A maximum diameter of the insulation sheet 500 may be equal to or similar to the diameter of the electrode assembly 300 such that the insulation sheet 500 covers the upper surface of the electrode assembly 300 as a whole.

When the insulation sheet 500 has a large diameter, the insulation area may be improved, but the cost and weight may increase. Therefore, the size of the insulation sheet 500 may be optimized and adjusted.

In some embodiments, the part of the first electrode tab 311 that is combined with the protrusion 421 may be exposed, and an insulation tape 312 may be attached to one area of the first electrode tab 311. As shown in FIG. 6, only one area of the end of the first electrode tab 311, which is the metal substrate, to be coupled to the protrusion 421 may be exposed, and the remaining part may be attached to the insulation tape 312 and insulated.

A minimum diameter of the insulation sheet 500 may be greater than the diameter D1 of the through hole 411 of the inner insulator 440, and a maximum diameter of the insulation sheet 500 may be formed in such a size that a portion of the insulation sheet 500 is attached to the insulation tape 312. Through this, the insulation sheet 500 may be securely attached to the inner insulator 440 and may have a minimum size such that the first electrode tab 311 is not exposed to the outside.

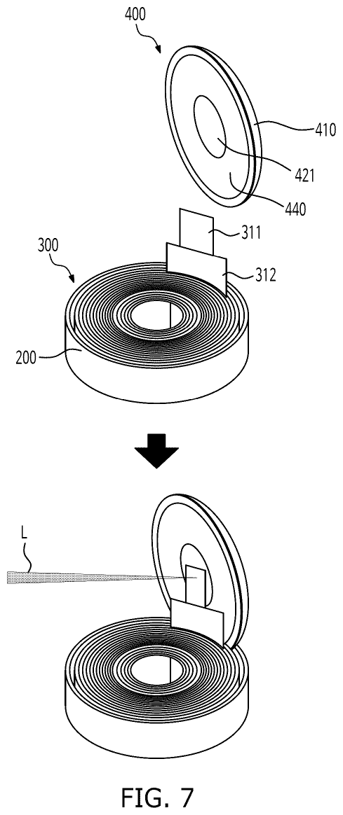

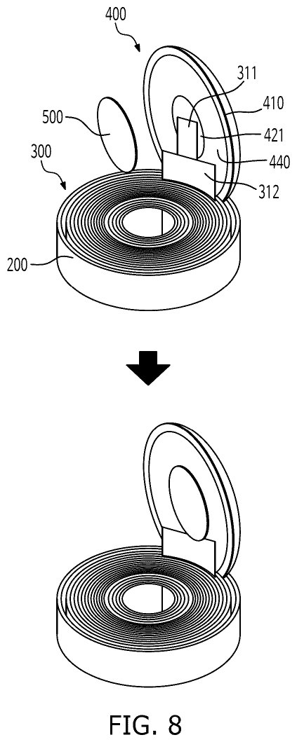

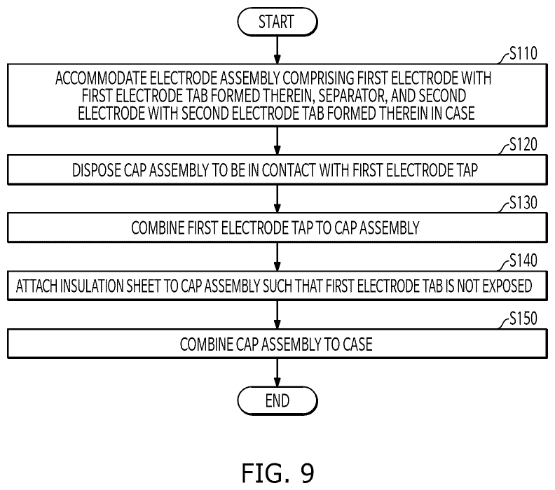

FIGS. 7 and 8 are diagrams showing an example of a method of manufacturing a secondary battery according to some embodiments of the present disclosure, and FIG. 9 is a flow chart showing an example of the method of manufacturing the secondary battery according to some embodiments of the present disclosure.

Referring to FIGS. 7 to 9, the method of manufacturing the secondary battery according to some embodiments of the present disclosure may include accommodating an electrode assembly 300 including a first electrode with the first electrode tab 311 formed therein, a separator, and a second electrode with a second electrode tab formed therein, in the case 200 (S110), disposing the cap assembly 400 to be in contact with the first electrode tab 311 (S120), combining the first electrode tab 311 to the cap assembly 400 (S130), attaching the insulation sheet 500 to the cap assembly 400 such that the first electrode tab 311 is not exposed (S140), and combining the cap assembly 400 to the case 200 (S150).

Disposing the cap assembly 400 (S120) may include disposing the cap assembly 400 in a perpendicular direction with respect to the case 200 in which the electrode assembly 300 is housed, as shown in FIG. 7. A jig device may support the case 200 and the cap assembly 400 such that the protrusion 421 provided in the cap assembly 400 may be disposed on the back of the first electrode tab 311 protruding upward from the electrode assembly 300 accommodated in the case 200.

For example, combining the first electrode tab 311 to the cap assembly 400 (S130) may include irradiating the first electrode tab 311 with a laser L to combine the first electrode tab 311 to the cap assembly 400 by laser welding, as shown in FIG. 7. In another example, the method of coupling the first electrode tab 311 to the protrusion 421 may include any suitable method.

Attaching the insulation sheet 500 to the cap assembly 400 (S140) may include attaching the insulation sheet 500 to the inner insulator 440 such that the first electrode tab 311 is not exposed. For example, the diameter of the insulation sheet 500 may be greater than the diameter of the insertion hole formed on the inner insulator 440, and may be equal to or smaller than the diameter of the inner insulator 440. The insulation sheet 500 may be attached to the inner insulator 440 to increase the adhesion of the insulation sheet 500. A minimum diameter of the insulation sheet 500 may be larger than the diameter of the insertion hole of the inner insulator 440. The insulation sheet 500 may be formed to have a maximum diameter smaller than that of the inner insulator 440 not to interfere the assembly of the cap plate and the case.

In another example, the diameter of the insulation sheet 500 may be greater than the diameter of the insertion hole of the inner insulator 440 and may be equal to or smaller than the diameter of the electrode assembly 300. In order for the insulation sheet 500 to be attached to the inner insulator 440, the minimum diameter of the insulation sheet 500 may be larger than the diameter of the insertion hole of the inner insulator 440. The maximum diameter of the insulation sheet 500 may be equal to or similar to the diameter of the electrode assembly 300 such that the insulation sheet 500 covers the upper surface of the electrode assembly 300 as a whole.

In yet another example, the minimum diameter of the insulation sheet 500 may be greater than the diameter of the insertion hole of the inner insulator 440, and the maximum diameter of the insulation sheet 500 may have a size such that a portion of the insulation sheet 500 is attached to the insulation tape 312. Through this, the insulation sheet 500 may be securely attached to the inner insulator 440 and may have a minimum size such that the first electrode tab 311 is not exposed to the outside.

By way of summation and review, if an insulation sheet is attached to the upper part of the electrode assembly in the form of winding, the insulation sheet may move due to poor adhesion, resulting in reduced performance of the electrode tab. In contrast, the present disclosure provides a secondary battery and a method of manufacturing the same, where an insulation sheet that insulates the electrode tab and the electrode assembly may be attached to the cap assembly to improve the adhesion of the insulation sheet. According to embodiments of the present disclosure, the insulation sheet may be attached to the cap assembly to fix the insulation sheet so that the insulation sheet does not move, thereby preventing a short circuit from occurring between the electrode tab and the electrode assembly.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode with a first electrode tab, a separator, and a second electrode with a second electrode tab;
a case accommodating the electrode assembly, the case being electrically connected to the second electrode tab;
a cap assembly that seals an open one side of the case, the cap assembly being electrically connected to the first electrode tab; and
an insulation sheet attached to the cap assembly, the insulation sheet electrically insulating the first electrode tab from the electrode assembly.

2. The secondary battery as claimed in claim 1, wherein the insulation sheet includes:
an insulation layer including an insulation material; and
an adhesive layer on the insulating layer, the adhesive layer attaching the insulating layer to the cap assembly.

3. The secondary battery as claimed in claim 2, wherein a thickness of the adhesive layer is equal to or greater than a size of a burr protruding from the first electrode tab.

4. The secondary battery as claimed in claim 1, wherein the cap assembly includes:
a cap plate that includes a through hole and is coupled to the case;
a terminal plate on an outer peripheral surface of the cap plate, the terminal plate including a protrusion inserted into the through hole of the cap plate and coupled to the first electrode tab;
an outer insulator between the cap plate and the terminal plate, the outer insulator insulating the cap plate from the terminal plate; and
an inner insulator including an insertion hole corresponding to the through hole of the cap plate, the inner insulator being on an inner peripheral surface of the cap plate and insulating the first electrode tab from the cap plate.

5. The secondary battery as claimed in claim 4, wherein the insulation sheet is attached to the inner insulator such that the first electrode tab is not exposed.

6. The secondary battery as claimed in claim 4, wherein a diameter of the insulation sheet is larger than a diameter of the insertion hole, and is equal to or smaller than an outer diameter of the inner insulator.

7. The secondary battery as claimed in claim 4, wherein a diameter of the insulation sheet is larger than a diameter of the insertion hole, and is equal to or smaller than a diameter of the electrode assembly.

8. The secondary battery as claimed in claim 4, wherein the first electrode tab includes an insulation tape exposing an area of the first electrode tab to be coupled to the protrusion of the terminal plate.

9. The secondary battery as claimed in claim 8, wherein a diameter of the insulation sheet is larger than a diameter of the insertion hole when the insulation sheet is attached to the insulation tape.

10. A method of manufacturing a secondary battery, the method comprising:
accommodating an electrode assembly in a case, the electrode assembly including a first electrode with a first electrode tab formed therein, a separator, and a second electrode with a second electrode tab formed therein;
disposing a cap assembly to be in contact with the first electrode tab;
combining the first electrode tab to the cap assembly;
attaching an insulation sheet to the cap assembly, such that the first electrode tab is not exposed; and
combining the cap assembly to the case.

11. The method as claimed in claim 10, wherein disposing the cap assembly includes disposing the cap assembly in a perpendicular direction with respect to the case.

12. The method as claimed in claim 10, wherein combining the cap assembly to the case includes irradiating the first electrode tab with a laser to combine the first electrode tab to the cap assembly by laser welding.

13. The method as claimed in claim 10, wherein the insulation sheet is formed to include:
an insulation layer made of an insulation material; and
an adhesive layer that is formed on one side of the insulating layer, and attaches the insulating layer to the cap assembly.

14. The method as claimed in claim 13, wherein a thickness of the adhesive layer is formed to be equal to or greater than a size of a burr protruding outward from the first electrode tab.

15. The method as claimed in claim 10, wherein the cap assembly is formed to include:
a cap plate that includes a through hole and is coupled to the case;
a terminal plate that is disposed on an outer peripheral surface of the cap plate, and includes a protrusion inserted into the through hole and coupled to the first electrode tab;
an outer insulator that is disposed between the cap plate and the terminal plate, and insulates the cap plate and the terminal plate; and
an inner insulator that includes an insertion hole corresponding to the through hole, is disposed on an inner peripheral surface of the cap plate, and insulates the first electrode tab and the cap plate.

16. The method as claimed in claim 15, wherein attaching the insulation sheet to the cap assembly includes attaching the insulation sheet to the inner insulator such that the first electrode tab is not exposed.

17. The method as claimed in claim 15, wherein a diameter of the insulation sheet is formed to be larger than a diameter of the insertion hole, and to be equal to or smaller than an outer diameter of the inner insulator.

18. The method as claimed in claim 15, wherein a diameter of the insulation sheet is formed to be larger than a diameter of the insertion hole, and to be equal to or smaller than a diameter of the electrode assembly.

19. The method as claimed in claim 15, wherein the first electrode tab is formed to include an insulation tape attached to an area such that a part to be coupled to the protrusion is exposed.

20. The method as claimed in claim 19, wherein a diameter of the insulation sheet is formed to be larger than a diameter of the insertion hole when the insulation sheet is attached to the insulation tape.
